(19) United States
(12) Patent Application Publication
(10) Pub. No.: US 2002/0138520 A1
(43) Pub. Date: Sep. 26, 2002

(54) SYSTEM AND METHODS FOR PUBLISHING AND DISTRIBUTING AN ELECTRONIC BOOK

(75) Inventors: Yoichi Wakai, Fujimi-machi (JP); Satoshi Nebashi, Cambridge (GB); Yasuhiro Nomura, Shiojiri-shi (JP); Yoshiiku Sendai, Matsumoto-shi (JP); Tetsuo Yamagishi, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 09/983,794

(22) Filed: Oct. 25, 2001

(30) Foreign Application Priority Data
Oct. 27, 2000 (JP) 2000-329363
Oct. 27, 2000 (JP) 2000-329364

(51) Int. Cl. G06F 15/00

(52) U.S. Cl. 707/517

(57) ABSTRACT

Information collecting means 9 collects provided information 27 which is added by a user operation to a container 1 storing electronic book data 26 in a storage unit 10 of a host computer 5. Editing means 11 edits the entirety or part of the collected provided information and adds the provided information to the electronic book data. Distribution means 15 adds the edited provided information to the electronic book data published by a publisher 6 and distributes the data.

With such a user-participating-type electronic book publishing system, the latest information and useful information can be extensively collected, and the electronic book data can be enriched.

### TECHNICAL FIELD

The present invention relates to electronic book publishing systems and publishing methods and to electronic information distributing apparatuses.

### BACKGROUND ART

In general, travelers carry a guidebook. Such a guidebook contains articles on travel preparation, airline ticket reservation, hotels, and the like. Travelers frequently use the guidebook by referring to pages with articles relevant to the trip. Some guidebooks include maps, practical articles on the local language, and the like. As time passes, these articles differ from the actual conditions. Revised editions are published relatively frequently for the convenience of readers. However, as for conventional published books, more detailed and specific contents would require the bookbinding to be thicker

Instead of books formed of printed paper, electronic books formed of electronized data have come to be widely used in many fields in order to reduce size and weight. One type of such an electronic book is one wherein information is written in a built-in ROM and read out from the ROM to be displayed. Another type includes a recording medium, such as a CD-ROM or a memory card, which is installed and read. It is likely that more and more electronic books using a removable recording medium such as a CD-ROM will be widely used since new content can be read at any time and hardware can be used continuously.

The above-described related art has the following problems to be solved.

For example, when a traveler carries a guidebook during his/her journey, the traveler may write down his/her comments on his/her journey in the guidebook. When the traveler finds an error in an article or obtains the latest information, the traveler may write it down in the guidebook in order to make the best use of it for a subsequent journey. Such information is not only useful to the carrier of the guidebook but also to other readers. Utilization of such information can improve the quality of the guidebook.

However, if information is collected from readers, it takes some time before the next revised edition can be printed. Handling of the collected information is not easy and depends on the editor's ability. In fact, there are many cases in which useful information is not utilized. Electronic books are often issued after books are printed. It is well desired to provide a system for extensively collecting new information and reflecting the information in publication.

Travel guidebooks are revised relatively frequently in order to reflect changes in public transportation schedules, hotel lodging expenses, and the like. However, it takes time to edit and print books. Even when a traveler purchases the latest edition and goes on a journey, the information on the guidebook may often be different from the actual situations. Information on relatively unpopular places is often old. Electronic books which use electronic data as a medium have a better chance of appropriately dealing with these changes in information immediately than books which use paper as a medium. For example, with a system capable of downloading the latest information through the Internet or the like, a travel guidebook which always contains the latest information can be realized.

When information of a size comparable to that of information included in the actual guidebook on sale is electronized, the amount of data becomes extremely large. There is a problem in that it takes a long period of time to download the information via a network. In a system for selling CD-ROMs at a book store, downloading is unnecessary. However, as with publishing books, there is a problem in that issuing CD-ROMs is slow to deal with changes in information.

As in newspapers and magazines, there is a system for speeding up the cycle from collecting information to publication, and for frequently publishing revised editions. When a traveler carries a guidebook on his/her journey, the traveler may write down his/her comments on his/her journey. When the traveler finds an error in an article or obtains the latest information, the traveler may write it down in the guidebook in order to make the best use of it for a subsequent journey. When revised editions are published frequently, such written information cannot be utilized unless it is posted. Since electronic books are read-only files, it has been impossible to write information into the electronic books.

### DISCLOSURE OF INVENTION

In order to solve the foregoing problems, the present invention adopts the following structure.

<Structure 1>

An electronic book publishing system including information collecting means for collecting provided information which is added by a user operation to a container storing electronic book data in a storage unit of a host computer; editing means for editing the entirety or part of the collected provided information and adding the edited provided information to the electronic book data; and distribution means for distributing the electronic book data to which the edited provided information is added.

Electronic book data is arbitrary information which can be displayed by operating an electronic book. A container storing the electronic book data can be a recording medium, such as a memory card or a floppy disk, or can be a built-in memory in the electronic book. Specifically, the container may be any medium or any unit containing a medium as long as the medium has a function of storing electronic information. Provided information is arbitrary information added to the electronic book data by a user operation. A host computer collects and utilizes the provided information. With such a user-participating-type electronic book publishing system, the latest information and useful information can be extensively collected, and the electronic book data can be enriched.

The host computer is connected to the container through an arbitrary interface and collects the provided information. The provided information collected in the storage unit is evaluated or selected if necessary. Then, the provided information is edited by the editing means and is added to the electronic book data. An editing method is arbitrary, and an adding method of adding data to the electronic book is also arbitrary. The method may be such that part of the electronic book data can be changed, or new data can be added to the electronic data. It is unnecessary to edit all the pieces of collected provided information. The distribution means can distribute the electronic book data via a network by an arbitrary method or can store the electronic book data in a distribution container. Alternatively, the electronic book data can be directly downloaded to a user's container through an interface. The editing means and the distribution means may be integrated with the host computer or may be independent of the host computer. The host computer, the editing means, and the distribution means may be connected to one another via a network.

<Structure 2>

An electronic book publishing system including information collecting means for collecting provided information which is added by a user operation to a container storing electronic book data in a storage unit of a host computer; editing means for editing the entirety or part of the collected provided information and generating additional data for the electronic book data; and distribution means for distributing the edited additional data.

Although the provided information is added to the electronic book data and distributed in structure 1, in this example, the provided information is distributed independently of the electronic book data.

<Structure 3>

An electronic book publishing system according to structure 1 or 2, wherein the editing means accepts an evaluation result of the collected provided information, edits the provided information selected in accordance with the evaluation result, and adds the provided information to the electronic book data.

Evaluation can be performed by an arbitrary method. When the evaluation results are input to the editing means, the editing means removes unnecessary provided information and performs editing. Accordingly, only useful provided information can be utilized.

<Structure 4>

An electronic book publishing system according to structure 1 or 2, wherein the host computer collects the provided information via a network.

By using the network, the provided information can be collected from a wide variety of sources.

<Structure 5>

An electronic book publishing system according to structure 1 or 2, wherein the host computer is connected via a network to a terminal provided with an interface for connecting the container, and collects the provided information through the terminal.

The terminal can be a user terminal or a shared terminal installed at a store or the like. The interface can be of any type as long as it has a function of reading the provided information from the container.

<Structure 6>

An electronic book publishing system according to structure 5, wherein the terminal collects the provided information when updating the electronic book data stored in the container.

When the provided information can be collected from the container at the same time as the electronic book data stored in the container is updated, it becomes unnecessary to perform special processing to collect the provided information.

<Structure 7>

An electronic book publishing system according to structure 5, wherein the terminal stores the provided information edited by the host computer in the container when updating the electronic book data stored in the container and collects the provided information which is additionally added to the electronic book by a user.

When the electronic book data is updated, the provided information edited at the host computer side can be stored in the container. The provided information edited by the host computer includes information provided from a third party. Accordingly, collecting the provided information from the user and feeding the provided information back to the user can be performed simultaneously.

<Structure 8>

An electronic book publishing system according to structure 1 or 2, wherein the provided information includes memo data input by the user operation.

The host computer collects useful information from the information that the user adds as a memo at an arbitrary place in the electronic book data while looking at the electronic book data.

<Structure 9>

An electronic book publishing system according to structure 1 or 2, wherein the provided information includes electrophotograph data captured by the user operation.

When the user takes a photograph related to an arbitrary portion of the electronic book data, the data is also collected as the provided information in the host computer.

<Structure 10>

An electronic book publishing system according to structure 1 or 2, wherein the provided information includes information of a location at which the user operation is performed.

For example, when the electronic book data includes data containing geographical factors in a guidebook, information of a location at which the user operation is performed in order to relate the provided information to an article in the electronic book data becomes useful. The location information is for specifying the place at which the user makes a memo or the like. The location information can be manually input by the user.

<Structure 11>

An electronic book publishing system according to structure 1 or 2, wherein the provided information includes longitude-and-latitude data obtained at a location at which the user operation is performed.

For example, when the longitude-and-latitude data which is automatically obtained by a location detecting system (GPS) using an artificial satellite at the same time as the user operation is performed, is added to the provided information, it is possible to provide the provided information of high value without causing the user to be aware of the operation.

<Structure 12>

An electronic book publishing system according to structure 1 or 2, wherein the provided information includes data specifying the date an time when the user operation is performed.

When information for specifying the date and time when the user operation is performed is included in the provided information, the newness of the collected data becomes clear. It thus becomes easy to evaluate the provided information.

<Structure 13>

An electronic book publishing system according to structure 1 or 2, wherein the provided information includes data specifying the date and time when the user operation is performed.

<Structure 14>

An electronic book publishing system according to structure 1 or 2, further including fee computing means for computing a fee in accordance with an evaluation result of the provided information.

With a system for automatically computing a value of information provided by a user and reimbursing the user for the value, it becomes possible to ensure the amount and quality of the provided information. The computed fee can be paid by an arbitrary method.

<Structure 15>

An electronic book publishing system according to structure 1 or 2, further including provided information evaluating means for collecting usability data from other users using the provided information; and fee computing means for computing a fee in accordance with the output of the provided information evaluating means.

An electronic book publishing system according to structure 1 or 2, further including an electronic book publishing system further including provided information evaluating means for collecting usability data from other users using the provided information; and fee computing means for computing a fee in accordance with the output of the provided information evaluating means.

The system collects data indicating the usability of the distributed provided information from users, evaluates the provided information after distributing the provided information, and reimburses a reasonable fee for valuable information.

<Structure 16>

An electronic book including a display for displaying electronic book data stored in a container; a user interface for storing, by a user operation, arbitrary data associated with the electronic book data in the container; and provided information designation means for designating provided information to be provided to a host computer among the data stored in the container by the user operation.

In order to achieve the invention as set forth in structure 1, a mechanism for causing the host computer to recognize the provided information in the container is necessary. The user can store arbitrary data related to the electronic book data in the container, and only data designated by a user out of the stored data can be supplied as the provided information.

<Structure 17>

An electronic book according to structure 6, wherein the provided information designation means is a data folder which is provided in the container and which only stores the provided information.

When the provided information is stored in a specific folder in the container and when the host computer automatically collects data in the folder, collecting processing by the host computer can be simplified.

<Structure 18>

An electronic book according to structure 16, further including longitude-and-latitude data measuring means for including longitude-and-latitude data which is measured when the user operation is performed in the provided information.

When the longitude-and-latitude data can be automatically detected by GPS or the like at the same time as the user operation is performed, the user is not required to input the location information.

<Structure 19>

An electronic book according to structure 16, wherein data added to the electronic book data by the user operation is stored in the container and is linked, by an icon on an electronic book data display screen, with data displayed on the display screen.

It is to improve the user-friendliness of inputting data such as the provided information or the like. The link is provided to relate displayed data to data input by the user operation, thereby enabling the user to refer to the data at any time. The link can be provided by a hyper-link technique or the like.

<Structure 20>

An electronic book publishing method including collecting provided information which is added by a user operation to a container storing electronic book data in a storage unit of a host computer; editing the entirety or part of the collected provided information and adding the edited provided information to the electronic book data; and distributing the electronic book data to which the edited provided information is added.

<Structure 21>

An electronic book publishing method including collecting provided information which is added by a user operation to a container storing electronic book data in a storage unit of a host computer; editing the entirety or part of the collected provided information and generating additional data for the electronic book data; and distributing the edited additional data.

<Structure 22>

An electronic information distributing apparatus including an interface for performing data communication with a container storing electronic information; an updating block determination unit for reading the electronic information through the interface, for detecting the version of each block of the electronic information, and for determining whether or not to update the electronic information in block units; a display unit for displaying a block to be updated on the basis of the determination result; and an updating processor for transmitting only the designated block to the container through the interface and for updating the corresponding block.

The container stores the electronic information. The contents of the electronic information can be displayed and viewed. The electronic information in the container is updated by the electronic information distributing apparatus. The electronic information is updated in block units. The block size and structure are arbitrary. By reducing the batch of data to be updated, the updating speed can be increased. The user can select a necessary portion of a block to be updated and then update the portion. Thus, the updating cost can be reduced. The contents of electronic information to be stored in the container are not restricted. The container may be a recording medium, such as a memory card or a floppy disk, or may be a portable terminal. Specifically, the container can be any medium or any unit containing a medium as long as the medium has a function of storing the electronic information.

Data communication between the container and the electronic information distributing apparatus through the interface can be performed with wire or wirelessly or can be performed using optical signals. When the container is a memory card, the interface includes a card slot and a data reading device. When the container is an information terminal, the interface is an infrared interface. Reading of electronic information by the electronic information distributing apparatus is performed only to read a portion which is required to determine the version of the electronic information in the container. A block to be updated can be displayed using a display, can be printed on paper, or can be output using voice. When the container is an information terminal, a block to be updated can be displayed on a display at the container side. Updating can be performed by overwriting data in block units or by adding new data to the container.

<Structure 23>

An electronic information distributing apparatus according to structure 22, wherein the block is a region obtained by dividing the electronic information into physical portions of a predetermined size.

When a region obtained by dividing the electronic information into physical portions of a predetermined size is referred to as a block, block management and version management can be easily performed. The user can select whether or not to perform updating in block units.

<Structure 24>

An electronic information distributing apparatus according to structure 22, wherein the block is a region obtained by dividing the electronic information by category.

Subdividing according to category means subdividing according to contents of the electronic information. For example, when the electronic information is for a travel guidebook, the electronic information can be subdivided according to journey destination. In this way, only a portion corresponding to a desired journey destination can be updated. Accordingly, the user can update only a necessary portion.

<Structure 25>

An electronic information distributing apparatus according to structure 1, further including block designation means for selecting and designating a block to be updated.

The block designation means may be an actual keyboard, a virtual keyboard displayed on a display, or audio response means. The block designation means can be of any type as long as it can enable the user to designate a block to be updated.

<Structure 26>

An electronic information distributing apparatus according to structure 1, wherein an arbitrary block of the electronic information includes succession information which is added as a result of the user operation; and, when updating the electronic information, the updating processor maintains the succession information as succession information for the new updated block.

Information which is added as a result of the user operation may include information which is directly recorded by the user or link data for linking the block to the information recorded by the user. Accordingly, information written by the user or the like can be succeeded after updating.

<Structure 27>

An electronic information distributing apparatus according to structure 5, wherein the succession information is information added to the electronic information by the user operation.

Information added to the container by the user operation can be utilized as data written to the electronic information after the electronic information is updated.

<Structure 28>

An electronic information distributing apparatus according to structure 5, wherein the succession information includes data for linking information added to the electronic information by the user operation with the corresponding block of the electronic information.

The block and the information written by the user in association with the block are linked by the link data. Accordingly, advantages similar to those in a case in which information is added to the block can be achieved.

<Structure 29>

An electronic information distributing apparatus according to structure 1, further including an updating fee computing unit for computing an updating fee per block and for charging the updating fee.

Since the system partially updates a block desired by the user at user's expense, the updating fee is computed and charged every time updating is performed. The updating fee computing unit can be an automatic-vending-machine-type apparatus for computing and collecting the updating fee or an apparatus for issuing a bill to be paid at a cashier. Alternatively, the updating fee computing unit can be an apparatus for automatically deducting the updating fee using a money card. When the updating fee is computed per updated block, the user can easily update and receive necessary information at a moderate price.

<Structure 30>

A computer-readable recording medium having recorded thereon a computer program including the steps of performing data communication with a container storing electronic information; reading the electronic information through an interface, detecting the version of each block of the electronic information, and determining whether or not to update the electronic information in block units; displaying a block to be updated on the basis of the determination result; and transmitting only the designated block to the container through the interface and updating the corresponding block.

This is an invention of a recording medium having recorded thereon a computer program for executing processing as set forth in structure 22.

<Structure 31>

A computer-readable recording medium according to structure 30, wherein the computer program further includes the step of selecting and designating the block to be updated.

This is an invention of a recording medium having recorded thereon a computer program for executing processing as set forth in structure 25.

<Structure 32>

A computer-readable recording medium according to structure 30, wherein, when succession information is added to an arbitrary block of the electronic information, the computer program further includes the step of maintaining the succession information as succession information for the new updated block when updating the electronic information.

This is an invention of a recording medium having recorded thereon a computer program for executing processing as set forth in structure 26.

<Structure 33>

A computer-readable recording medium according to structure 30, wherein the computer program further includes the step of computing an updating fee per updated blocks and charging the updating fee.

This is an invention of a recording medium having recorded thereon a computer program for executing processing as set forth in structure 29.

### BRIEF DESCRIPTION OF THE DRAWINGS

FIG. 1 is a conceptual diagram illustrating a specific example of an electronic book publishing system of the present invention.

FIG. 2(a) is a plan view of an electronic book for implementing the present invention, and FIG. 2(b) is a perspective view thereof.

FIG. 3 illustrates the contents of electronic information to be stored in a container.

FIG. 4 is a block diagram illustrating the internal structure of the electronic book.

FIG. 5 illustrates the relationship between electronic book data displayed on the electronic book and memo data 46 and the like.

FIG. 6 illustrates a method of transmitting, to a host computer, provided information selected from memo data that is stored by a user in the container.

FIG. 7 is a block diagram of a specific example of an electronic information distributing apparatus of the present invention.

FIG. 8(a) is a plan view of an electronic book for implementing the present invention, and FIG. 8(b) is a perspective view thereof.

FIG. 9 illustrates the contents of electronic information to be stored in the container.

FIG. 10 is a flowchart showing the updating operation performed by the electronic information distributing apparatus shown in FIG. 7.

FIG. 11 is a block diagram of an updating system which utilizes a network including the electronic information distributing apparatus, an electronic book publisher, and the user.

### DESCRIPTION OF THE PREFERRED EMBODIMENTS

Embodiments of the present invention will now be described with specific examples.

(First Embodiment)

(System Configuration)

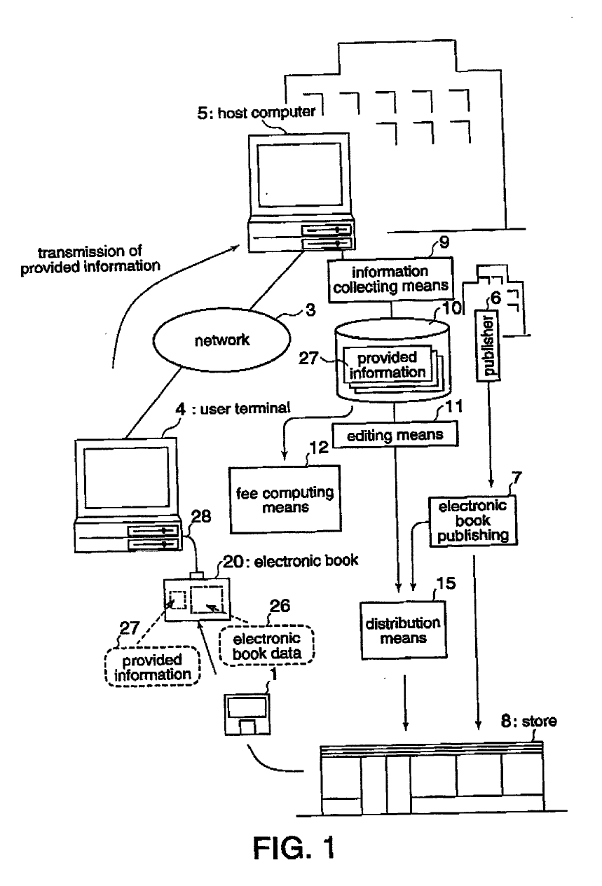

FIG. 1 is a conceptual diagram showing a specific example of an electronic book publishing system of the present invention.

The illustration shows the flow of electronic book data and information provided by a user in the electronic book publishing system. A user terminal 4 and a host computer 5 are connected to a network 3 such as the Internet. The user displays and utilizes electronic book data 26 stored in a container 1 such as a floppy disk using an electronic book 20. In the drawing, the electronic book 20 and the user terminal 4 are connected to each other by an interface cable 28 so that provided information 27 stored in the container 1 can be transmitted to the host computer 5.

The user stores comments made while looking at the electronic book data 26 for, for example, a travel guidebook and errors detected in the electronic book data 26 as the provided information 27 in the container 1. The user transmits the provided information 27 to the host computer 5 so that these pieces of information can be reflected in electronic book data to be subsequently published. In this system, the user participates in publishing electronic book data. As described hereinafter, the user can store various types of information other than the information provided in the container 1. In the drawing, only the provided information 27 is shown.

A publisher 6, shown in the drawing, publishes various electronic books and sells these electronic book data at a store 8. The electronic book data is stored in the container 1 such as a floppy disk and is sold. The store 8 at which the electronic book data is sold may be a book store or a convenience store. The provided information 27 from the user is collected by information collecting means 9 of the host computer 5, and is stored in a storage unit 10.

Editing means 11 edits the collected provided information 27 and adds the edited provided information 27 to electronic book data published by the publisher 6. For example, the editing means 11 extracts pieces of information designated by an operator (not shown) out of the provided information 27 from the storage unit 10 and edits an electronic book page in which the pieces of provided information are arranged as in a letter-to-the editor column. Provided information other than the designated pieces can be thrown out. Distribution means 15 is a portion which performs processing to distribute the electronic book data to which the edited provided information is added. For example, the distribution means 15 makes a large number of copies of the container storing the provided information and the electronic book data. The copied containers are dispatched to the store 8.

The container 1 storing the electronic book data 26 may be a recording medium, such as a memory card or a floppy disk, or a built-in memory in the electronic book 20. In other words, the container 1 is not necessarily required to be removable from the electronic book 20. The host computer 5 collects the provided information 27 through an arbitrary interface. In the example shown in the drawing, the user terminal 4 and the network 3 are used as an interface. Alternatively, for example, a terminal for collecting provided information can be installed at the store 8 so that the user can freely use the terminal.

Preferably, the terminal (not shown) installed at the store 8 not only collects the provided information but also has a function of updating electronic book data used by the user. The terminal simultaneously updates the electronic book data and collects the provided information. Also, the terminal can distribute the provided information. Accordingly, collecting the provided information from the user and feeding the provided information back to the user can be performed simultaneously. The provided information can be added to the electronic book data and distributed. Alternatively, the provided information can be distributed independently of the electronic book data. When the electronic book 20 has a cellular phone function, a cellular phone network is used as the network 3, and updating and collection and distribution of information can be performed. At this time, the user terminal 4 is a cellular phone or a mobile computer.

The system shown in the drawing is provided with fee computing means 12. The collected provided information 27 is, for example, edited and evaluated by an editor (not shown), and the quality of the provided information 27 is judged. At the same time, the rank of a fee to be paid to the provider of the information is determined. The fee computing means 12 automatically issues a message for the purpose of paying a fee and makes a remittance. With the system, useful information can be collected more easily. Optionally, the system can register the provider of the information as a member and automatically reimburse the user by canceling out the charge for updating the electronic book data as for the information provided.

(Structure of Electronic Book)

The structure of an electronic book which is effective in operating the system as described above will now be described.

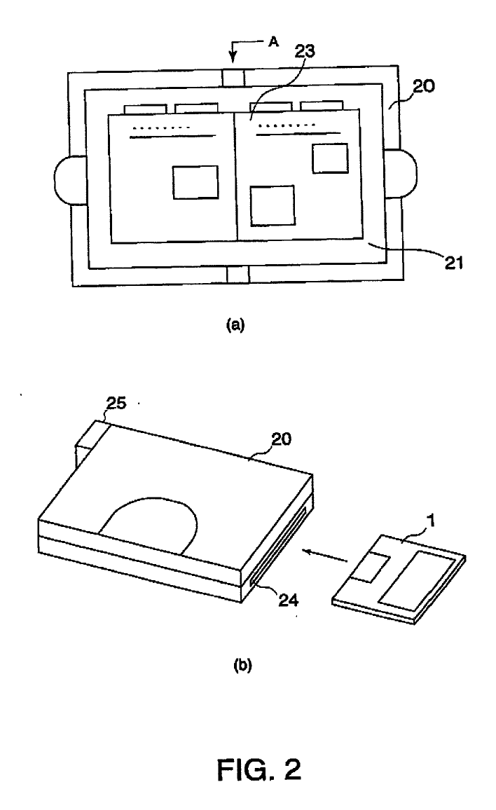

FIG. 2(a) is a plan view of an electronic book for implementing the present invention, and FIG. 2(b) is a perspective view thereof.

An electronic book 20 can be folded in half at a portion indicated by arrow A in FIG. 2(a). The state in which the electronic book 20 is folded is shown by FIG. 2(b). The electronic book 20 includes a display 21 which displays a screen 23 of a travel guidebook. As shown in FIG. 2(b), the container 1 is mounted on a lateral side of the electronic book 20. In this example, the container 1 is a floppy disk, and the electronic book 20 includes a floppy disk drive 24. The container 1 is placed in the floppy disk drive 2A. In addition to this, the electronic book 20 is provided with an electronic camera 25. An image captured by the electronic camera 25 is stored in the container 1. The image data can also be used as provided information.

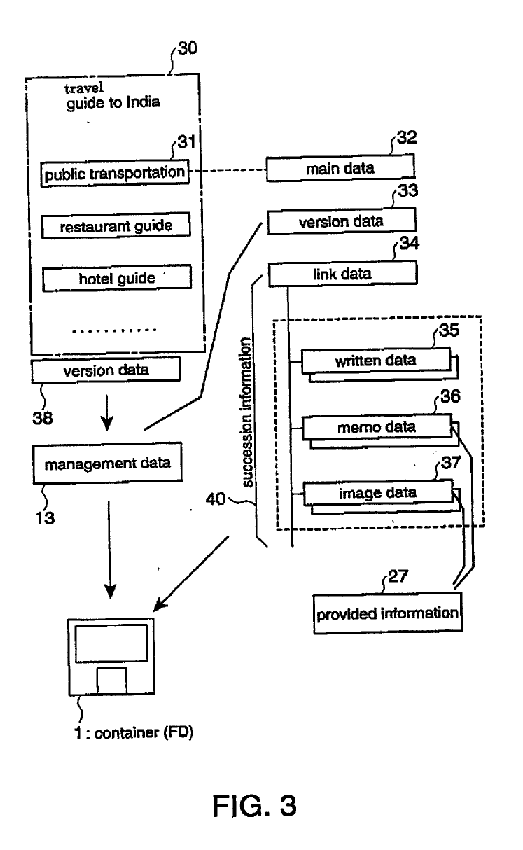

FIG. 3 illustrates the contents of electronic information to be stored in the container.

When the electronic information is for a travel guidebook, for example, the entire data is divided into blocks according to destination. In this drawing, a large block 30 “Travel Guide to India” is shown. The large block 30 includes data for subdivided blocks including public transportation, restaurant guide, hotel guide, and the like. For example, the electronic book data can be updated in units of large blocks or in units of subdivided blocks. Accordingly, the cost of obtaining the latest electronic book data can be reduced. If the amount of data is reduced, the cost and time for updating data through a communication network can be saved.

For example, a block 31 shown in FIG. 3 includes main data 32, version data 33, and link data 34. The main data 32 includes text data and image data for displaying articles on public transportation used for traveling in India. The version data 33 includes data indicating the version of the block and is used to determine whether it is necessary to update the data or not. In the example shown in the drawing, the version data 33 is included in management data 13 separately from the main data 32. Version data 38 in the large block 30 is similarly included in the management data. The management data 13 is stored in the container 1.

The link data 34 includes data for linking the main data 32 with data additionally written by the user in association with the articles in the main data 32 in the block. For example, the link data 34 includes data describing an icon arranged in the displayed electronic book data and a command for opening a data file which is additionally written by the user in response to clicking the icon. Examples of data written by the user include written data 35, memo data 36, image data 37, and the like.

The written data 35 includes data generated by the user who writes down comments regarding arbitrary articles while looking at the display (FIG. 2) of the electronic book. The written comments are saved as the written data 35. The memo data 36 includes data generated by the user who saves his/her comments regarding the corresponding block as a file in a text data format. The image data 37 includes a hand-drawn image, an image received from a scanner, and an image captured by the electronic camera 25 (FIG. 2). In this example, the written data 35, the memo data 36, and the image data 37 are all stored in the container 1. When a block is updated, only the main data 32 is rewritten. The link data 34, the written data 35, the memo data 36, and the image data 37 are succeeded without being changed. To this end, the main data 32 is stored in the container separate from the other data. Data which is referred to as data input by a user operation in the present invention is succession information 40.

Accordingly, the written information is stored unaltered even when information is written in the electronic book data, and the electronic book data is updated. The succession information 40 includes information which is privately maintained by the user. Only information which the user wants third parties to use is designated as the provided information 27. For example, when only the provided information 27 is stored in a specific folder, the provided information 27 can be distinguished from other data.

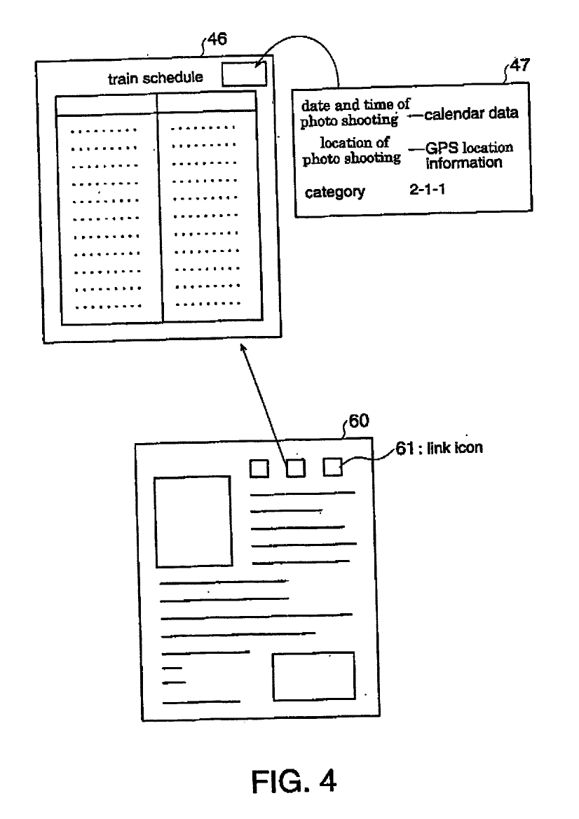

FIG. 4 is a block diagram illustrating the internal structure of the electronic book.

As shown in the diagram, the electronic book includes a touch panel 41, an image data processor 51, a character recognition unit 52, a GPS unit 53, a storage unit 55, and an image processor 57. The touch panel 41 is a known device through which hand-written characters and pictures are input with a pen 42. The image data processor 51 has a function to process signals input from the touch panel 41 and store the processed signals as the memo data 46 in the storage.

The character recognition unit 52 has a function to recognize characters input via the touch panel 41 and to convert the characters into character code. The GPS unit 53 receives satellite signals and obtains location information by performing the known operation. Location information 54 is stored as attribute data of the memo data 46 in the storage unit 55. The image processor 57 has a function to compress image data captured by the electronic camera 25 (FIG. 2) and to store the image data in the storage unit 55. The image data processor 51, the character recognition unit 52, and the image processor 57 can be formed of dedicated hardware or software.

As described above, data generated by the user writing down comments while looking at the electronic book data and captured data are stored as the memo data 46 in the electronic book. The data is stored in the container 1 shown in FIG. 3 at a predetermined timing. The storage unit 55 shown in the diagram is used as a buffer memory. Alternatively, data can be directly written to the container 1 without such a storage unit. In addition to the above-described interface, various user interfaces including a microphone for inputting audio and a keyboard for inputting characters can be used to input memo data.

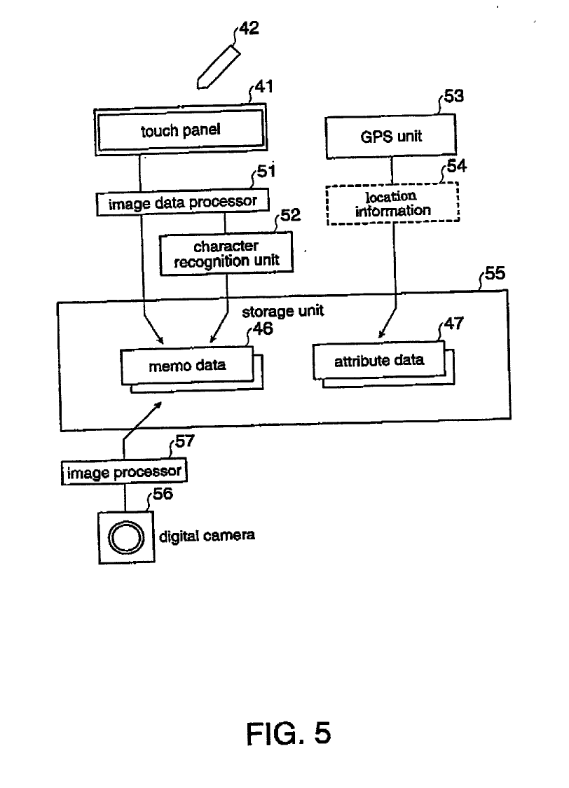

FIG. 5 illustrates the relationship between the electronic book data displayed on the electronic book and the memo data 46 or the like.

As shown in the drawing, when the user looks at a page 60 of the electronic book data displayed on the electronic book 20 (FIG. 1) and creates the memo data 46, a link icon 61 is displayed in the corner of the page 60. When the icon 61 is clicked, the memo data 46 is displayed. The memo data 46 is obtained as a result of capturing, by the user, an image of a train schedule using the electronic camera 25 during his/her journey. At the time the image is captured, a built-in clock (not shown) in the electronic book 20 obtains the date and time of the photo shooting and stores the date and time as the attribute data 47. The GPS unit 53 (FIG. 4) obtains location information and stores the location information as the attribute data 47. The contents of the attribute data 47 are displayed, for example, in the upper corner of the memo data 46.

The data illustrated in the drawing is useful for users other than this user. The data is transmitted as the provided information to the host computer 5 shown in FIG. 1. After the host computer 5 collects and distributes the provided information, the time schedule memo page can be viewed by third parties in exactly the same manner as shown in FIG. 5.

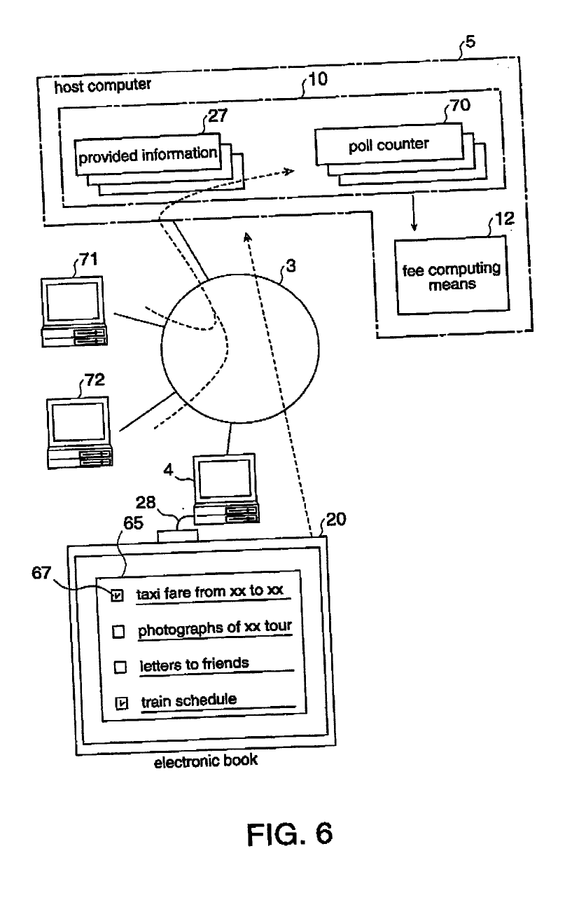

FIG. 6 illustrates a method of transmitting provided information, which is selected from the memo data stored in the container by the user, to the host computer.

As shown in the drawing, the electronic book 20 is connected to the user terminal 4 through the interface cable 28. A list 65 of the memo data stored by the user in the container is displayed. Data displayed by checking a check box 67 on the list 65 is the provided information. The electronic book 20 transmits the provided information to the host computer 5 through the interface cable 28, the user terminal 4, and the network 3. With designation means for designating the provided information, only information designated by the user can be transmitted to the host computer.

The storage unit 10 of the host computer 5 stores a poll counter 70 for popularity polls. When other users use any of the provided information, the poll counter 70 is used to indicate the evaluation of the provided information in terms of a poll. Specifically, other users who view the provided information added to the electronic book data cast votes for the popularity poll using terminals 71 and 72 at appropriate timing. For example, the message “Please mark three pieces of provided information which were useful in the purchased electronic book data” is displayed, and evaluations from other users are obtained. The fee computing means 12 judges the value of the provided information 27 based on the evaluation results. In accordance with the evaluated value, the fee to be paid to the user who has provided the provided information is computed.

As described above, with provided information evaluation means for collecting usability data from other users using the provided information, the user begins supplying more valuable provided information, and easy-to-use electronic book data can be published. Since electronic data is directly collected from users, for example, it does not take a lot of time and labor to edit the data in a letter-to-the editor column style, for example. It is thus possible to process the provided information quickly at low cost so that other users can use the provided information.

The present invention is not limited to the above examples. For example, when the electronic book data is updated, the electronic book data is partially updated only for the necessary portions, and thereby, the cost of obtaining the data can be reduced. Also, it is possible to employ the system that compensates the user for the provided information by offering a discount on the updating fee. In another method, the amount of provided information can be summed for each user, and points are earned. In accordance with the points, the updating fee can be reduced.

As described above, with the user-participating-type electronic book publishing system for receiving, collecting, and distributing information provided by users, the latest information and useful information can be extensively collected, and electronic book data can be enriched. It is also possible to quickly distribute information requested by users.

(Second Embodiment)

An embodiment of the present invention will now be described with specific examples.

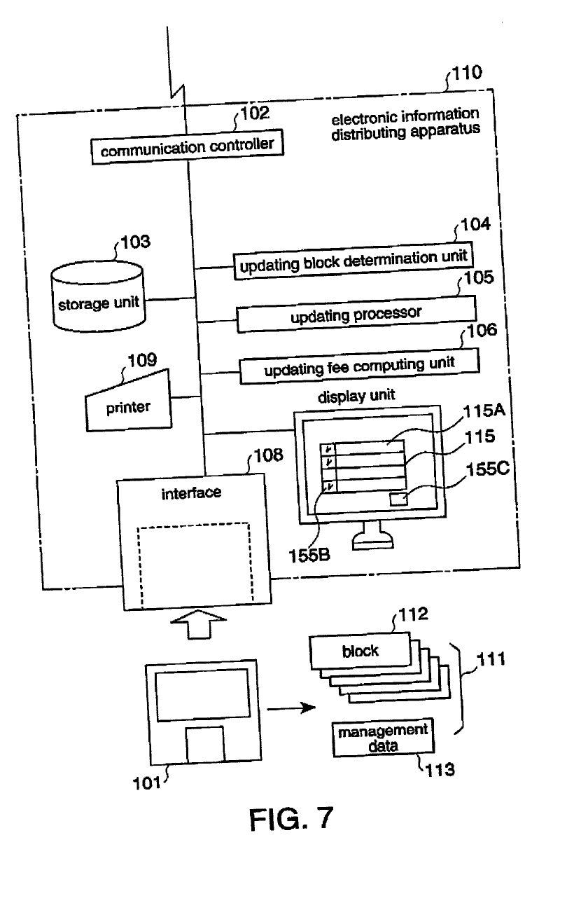

FIG. 7 is a block diagram illustrating a specific example of an electronic information distributing apparatus of the present invention.

An electronic information distributing apparatus 110 shown in the drawing is an apparatus for updating a container 101 which stores electronic information for an electronic book. In the example shown in the drawing, the container 101 is a floppy disk. Alternatively, various other types of the container 101 including a memory card and a CD-ROM can be used. In the container 101, electronic information 111 is stored in units of blocks of an appropriate size. The electronic information distributing apparatus 110 has a function to update the electronic information in block units.

The electronic information distributing apparatus 110 shown in the drawing includes a communication controller 102, a storage unit 103, an updating block determination unit 104, an updating processor 105, an updating fee computing unit 106, a display unit 107, an interface 108, and a printer 109. The communication controller 102 is connected to a host computer (not shown) and has a function to receive electronic information for updating. The storage unit 103 stores the received electronic information for updating. The updating block determination unit 104 has functions to read the electronic information 111 stored in the container 101 through the interface 108, detect the version of each block 112 of the electronic information 111, and determine whether or not to update the electronic information 111 in block units. Thus, the electronic information 111 includes table data for displaying a list of versions of all the blocks. This is included in management data 113.

The display unit 107 is used to display the determination results of the updating block determination unit 104. Based on the determination results of the updating block determination unit 104, a user can detect blocks whose versions are old. The display unit 107 displays block designation means 115. The block designation means 115 includes a list of blocks to be updated and a window displaying a group of check boxes for designating blocks that the user wants to update. The updating processor 105 has functions to transmit, when the user operates the block designation means 115 and designates a block(s) to be updated, the corresponding block(s) to the container 101 through the interface 108 and update the corresponding blocks.

The updating fee computing unit 106 has a function to compute the updating fee to be charged to the user on the basis of the updating result. The number of updated blocks, and the like are taken into consideration in computing the updating fee. The result of computing the updating fee is, for example, printed by the printer 109. The printer 109 is used to issue a bill. The bill is used in such a manner that the user brings the bill to a cashier (not shown) and pays the updating fee.

The updating block determination unit 104, the updating processor 105, and the updating fee computing unit 106 are implemented by a computer program executed by a processor (not shown) of the electronic information distributing apparatus 110.

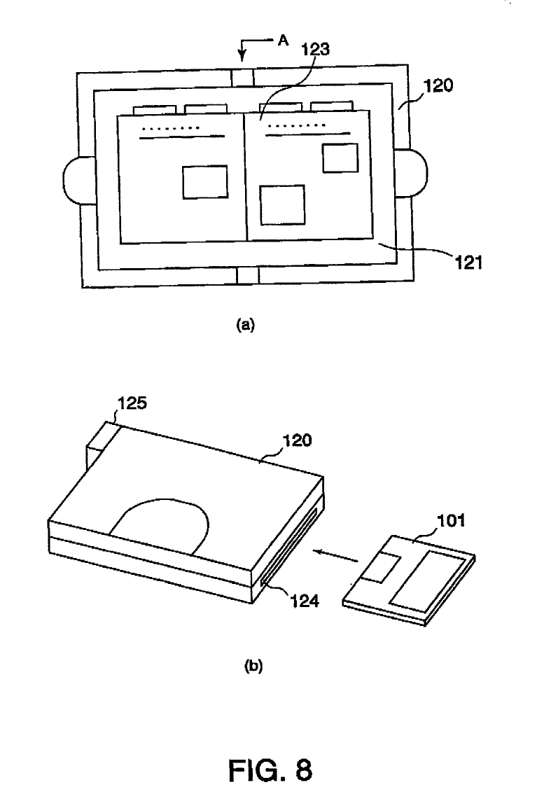

FIG. 8(a) is a plan view of an electronic book for implementing the present invention, and FIG. 8(b) is a perspective view thereof.

An electronic book 120 can be folded in half at a portion indicated by arrow A in FIG. 8(a). The state in which the electronic book 120 is folded is shown by FIG. 8(b). The electronic book 120 includes a display 121 which displays a screen 123 of a travel guidebook, for example. As shown in FIG. 8(b), a container 101 is mounted on a lateral side of the electronic book 120. In this example, the container 101 is a floppy disk, and the electronic book 120 includes a floppy disk drive 124. The container 101 is placed in the floppy disk drive 124. In addition to this, the electronic book 120 is provided with an electronic camera 125. An image captured by the electronic camera 125 is stored in the container 101.

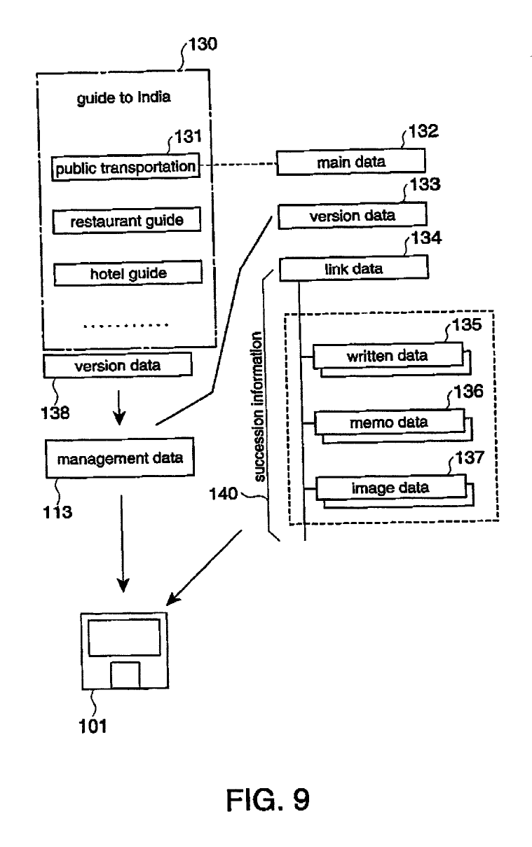

FIG. 9 illustrates the contents of electronic information to be stored in the container.

When the electronic information is for a travel guidebook, for example, the entire data is divided into blocks according to destination. In this drawing, a large block 130 “Travel Guide to India” is shown. The large block 130 includes data for subdivided blocks including public transportation, restaurant guide, hotel guide, and the like. For example, the electronic book data can be updated in units of large blocks or in units of subdivided blocks.

For example, a block 131 shown in FIG. 9 includes main data 132, version data 133, and link data 134. The main data 132 includes text data and image data for displaying articles on public transportation used for traveling in India. The version data 133 includes data indicating the version of the block and is used to determine whether it is necessary to update the data or not. In the example shown in the drawing, the version data 133 is included in management data 113 separately from the main data 132. Version data 138 in the large block 130 is similarly included in the management data. The management data 113 is stored in the container 101. Accordingly, the updating block determination unit 104 shown in FIG. 7 can determine the version of each block.

The link data 134 includes data for linking the main data 132 with data additionally written by the user in association with the articles in the main data 132 in the block. For example, the link data 134 includes data for associating the identification number of a block with a storage location of data additionally written by the user. This is provided in order to manage data added to each block. Examples of data additionally written by the user include the written data 135, the memo data 136, the image data 137, and the like.

The written data 135 includes data generated by the user who writes down comments regarding arbitrary articles while looking at the display (FIG. 8) of the electronic book. The written comments are saved as the written data 135. The memo data 136 includes data generated by the user who saves his/her comments regarding the corresponding block as a file in a text data format. The image data 137 includes a hand-drawn image, an image received from a scanner, and an image captured by the electronic camera 125 (FIG. 8). In this example, the written data 135, the memo data 136, and the image data 137 are all stored in the container 101. When a block is updated, only the main data 132 is rewritten. The link data 134, the written data 135, the memo data 136, and the image data 137 are succeeded without being changed. To this end, the main data 132 is stored separately from the other data. The link data 134, the written data 135, the memo data 136, and the image data 137 are referred to as succession information 140.

Accordingly, even when information is written in a certain block in the travel guidebook, and the block is updated, the written information is stored unaltered. The information including the succession information can be used even when the container 101 is mounted on a different electronic book as long as all the information concerning the travel guidebook is stored in the container 101.

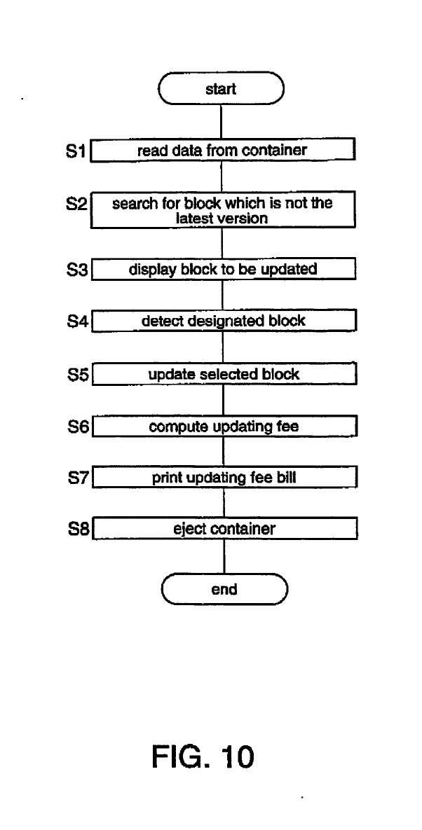

FIG. 10 is a flowchart showing the updating operation of the electronic information distributing apparatus shown in FIG. 7.

With the flowchart, the operation of the electronic information distributing apparatus 110 when the user of the electronic book 120 updates the travel guidebook stored in the container 101 will now be described. The user removes the container 101 from the electronic book 120. The user mounts the container 101 on the interface 108 of the electronic information distributing apparatus 110 shown in FIG. 7 and presses an update start button (not shown) displayed on the display unit 107. The display unit 107 is a touch panel. The display unit 107 can be operated by pressing a displayed image. The latest-version electronic information 111 is downloaded from a host computer (not shown) and stored in the storage unit 103 of the electronic information distributing apparatus 110.

When the updating operation starts, in step S1, the interface 108 reads data from the container 101 and transfers the data to the updating block determination unit 104.

The updating block determination unit 104 refers to the management data 113 stored in the container 101, and compares the data with the latest-version electronic information stored in the storage unit 103 and searches for blocks which are not the latest version (step S2). As a result, blocks to be updated are displayed on the display unit 7 (step 3).

On the display unit 107, the block designation means 115 shown in FIG. 7 is provided with contents 115A of the blocks to be updated and check boxes 115B to be checked when the user wants to update the corresponding blocks. When the check box 115B is pressed by finger, the check box 115B is checked, and hence the block to be updated can be designated. Subsequently, when an update start button 115C is pressed, the updating processor 105 detects blocks which are designated to be updated by the block designation means 115 (step S4).

The updating processor 105 reads data for the corresponding blocks from the storage unit 103, transfers the data to the container 101, and updates the blocks (step S5). The processing is performed only for the main data 132 (FIG. 9) of each block 112 which has already been described. The updating fee computing unit 106 accumulates updating charges for updated blocks and computes an updating fee. Based on the result, the printer 109 prints a bill (step S7). The interface 108 ejects the updated container 1 and returns the container 1 to the user (step S8). The user pays the fee on the bill at a cashier, mounts the container 1 on the electronic book 120, and starts using the updated-version travel guidebook.

When electronic book data is updated in units of blocks designated by the user by the above-described method, only necessary portions of the electronic book data are quickly updated at low cost. In the guidebook, only information which tends to change due to the local circumstances, namely, ticket prices, dining expenses, accommodation expenses, and medical expenses, can be updated immediately before traveling, enabling the user to use the latest information during his/her travel. As described above, updating can be performed in units of large blocks or in units of subdivided blocks. Thus, updating fees differ according to the blocks to be updated. When the block designation means 115 display updating fees in units of blocks to be updated, the user can select blocks to be updated in accordance with his/her budget.

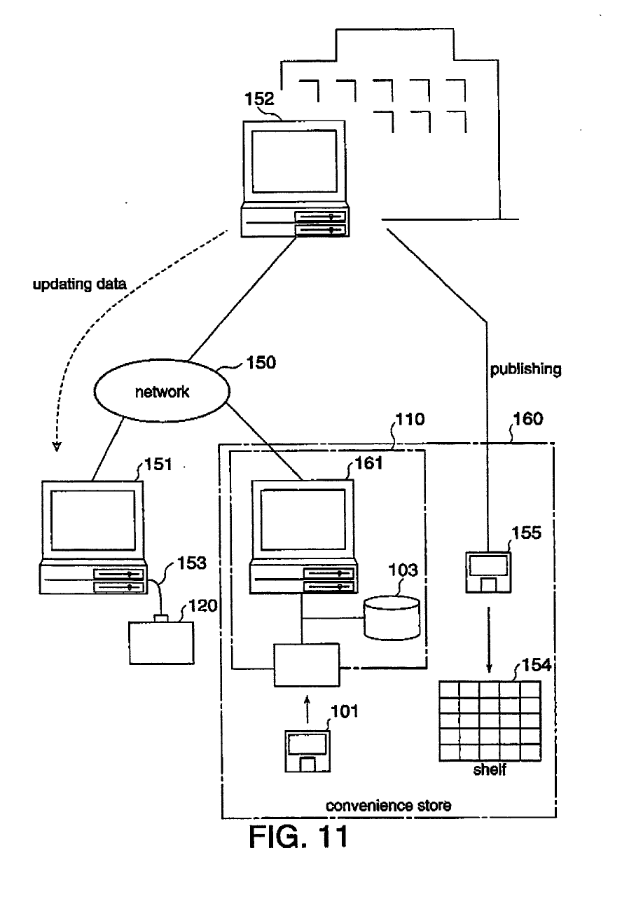

FIG. 11 is a block diagram of an updating system using a network including the electronic information distributing apparatus, the electronic book publisher, and the user.

As shown in the drawing, a user terminal 151, a host computer 152 of the electronic book publisher, and the electronic information distributing apparatus 110 are connected to a network 150 such as the Internet. When the publisher publishes an electronic book, the publisher sells a container 155 containing the entire electronic book. For example, containers for electronic books in various fields are on a shelf 154 of a convenience store 160 and are on sale. A user who purchases the container 155 uses the container 155 on his/her electronic book 120.

In the convenience store 160, the above-described electronic information distributing apparatus 110 is installed. The user brings the container 101 to the convenience store 160 and updates the container 101. In this system, the container 101 can be updated by using the user terminal 151. In this case, electronic book data is downloaded in block units through the network 150. Preferably, updating can be performed by connecting the electronic book 120 and the terminal 151 to each other through an interface cable 153. In this case, the electronic book 120 becomes the display unit 107 shown in FIG. 7, and the block designation means is displayed on the electronic book. In this case, the updating fee may be paid by card or the like. The network 150 shown in the drawing may be a wireless network for cellular phones and the like. In this case, the terminal 151 may be a cellular phone or a mobile computer.

The above described cases are illustrative examples, and the present invention is not limited thereto. Functional blocks in the electronic information distributing apparatus 110 shown in FIG. 7 may be formed of separate program modules or formed of an integrated program module. All or some of the functional blocks may be formed of logical circuit hardware. Each program module may be loaded into a known application program and operated or may be operated as an independent program. The functions of the electronic information distributing apparatus 110 can be implemented by installing a computer program which operates as described above on a known computer. The computer program for implementing the present invention may be recorded on a computer-readable recording medium such as a CD-ROM, and the computer program may be installed and used. The computer program may be downloaded via a network into a memory of a computer and be used.

As described above, electronic books are small and lightweight and are easy to carry. Creation of an environment for updating electronic information on an electronic book in block units at a convenience store enables a user to use an electronic book which always contains the latest information when necessary. With a system for comparing the current contents with the latest contents and only updating portions designated by the user, updating can be performed in a short period of time. This lessens the burden on the user and reduces the cost of providing information. Furthermore, data including written data can be updated. It is thus possible to achieve an electronic information distributing apparatus which uses the electronic book including user's original information.

1) an electronic book publishing system comprising:
information collecting means for collecting provided information which is added by a user operation to a container storing electronic book data in a storage unit of a host computer;
editing means for editing the entirety or part of the collected provided information and adding the edited provided information to the electronic book data; and
distribution means for distributing the electronic book data to which the edited provided information is added.

2) An electronic book publishing system comprising:
information collecting means for collecting provided information which is added by a user operation to a container storing electronic book data in a storage unit of a host computer;
editing means for editing the entirety or part of the collected provided information and generating additional data for the electronic book data; and
distribution means for distributing the edited additional data.

3) An electronic book publishing system according to claim 1 or 2, wherein the editing means accepts an evaluation result of collected provided information, edits provided information selected in accordance with the evaluation result, and adds the edited provided information to electronic book data.

4) An electronic book publishing system according to claim 1 or 2, wherein the host computer collects provided information via a network.

5) An electronic book publishing system according to claim 1 or 2, wherein the host computer is connected via a network to a terminal provided with an interface for connecting the container, and collects provided information through the terminal.

6) An electronic book publishing system according to claim 5, wherein the terminal collects provided information when updating electronic book data stored in the container.

7) An electronic book publishing system according to claim 5, wherein the terminal stores provided information edited at the host computer in the container when updating electronic book data stored in the container and collects new provided information which a user adds to an electronic book.

8) An electronic book publishing system according to claim 1 or 2, wherein provided information comprises memo data input by a user operation.

9) An electronic book publishing system according to claim 1 or 2, wherein provided information comprises electrophotograph data captured by a user operation.

10) An electronic book publishing system according to claim 1 or 2, wherein provided information comprises information of a location at which a user operation is performed.

11) An electronic book publishing system according to claim 1 or 2, wherein provided information comprises longitude-and-latitude data obtained at a location at which a user operation is performed.

12) An electronic book publishing system according to claim 1 or 2, wherein provided information comprises data specifying the date and time when a user operation is performed.

13) An electronic book publishing system according to claim 1 or 2, wherein provided information comprises data specifying the date and time when a user operation is performed.

14) An electronic book publishing system according to claim 1 or 2, further comprising fee computing means for computing a fee in accordance with an evaluation result of provided information.

15) An electronic book publishing system according to claim 1 or 2, further comprising:
provided information evaluating means for collecting usability data from other users using provided information; and
fee computing means for computing a fee in accordance with an output of the provided information evaluating means.

16) An electronic book comprising:
a display for displaying electronic book data stored in a container;
a user interface for storing, by a user operation, arbitrary data associated with the electronic book data in the container; and
provided information designation means for designating provided information to be provided to a host computer among the data stored in the container by the user operation.

17) An electronic book according to claim 16, wherein the provided information designation means is a data folder which is provided in the container and which only stores provided information.

18) An electronic book according to claim 16, further comprising longitude-and-latitude data measuring means for including longitude-and-latitude data which is measured when a user operation is performed in provided information.

19) An electronic book according to claim 16, wherein data added to electronic book data by a user operation is stored in the container and is linked, by an icon on an electronic book data display screen, with data displayed on the display screen.

20) An electronic book publishing method comprising:
collecting provided information which is added by a user operation to a container storing electronic book data in a storage unit of a host computer;
editing the entirety or part of the collected provided information and adding the edited provided information to the electronic book data; and
distributing the electronic book data to which the edited provided information is added.

21) An electronic book publishing method comprising:
collecting provided information which is added by a user operation to a container storing electronic book data in a storage unit of a host computer;
editing the entirety or part of the collected provided information and generating additional data for the electronic book data; and
distributing the edited additional data.

22) An electronic information distributing apparatus comprising:
an interface for performing data communication with a container storing electronic information;
an updating block determination unit for reading the electronic information through the interface, for detecting the version of each block of the electronic information, and for determining whether or not to update the electronic information in block units;
a display unit for displaying a block to be updated on the basis of the determination result; and
an updating processor for transmitting only the designated block to the container through the interface and for updating the corresponding block.

23) An electronic information distributing apparatus according to claim 22, wherein the block is a region obtained by dividing electronic information into physical portions of a predetermined size.

24) An electronic information distributing apparatus according to claim 22, wherein the block is a region obtained by dividing electronic information by category.

25) An electronic information distributing apparatus according to claim 22, further comprising block designation means for selecting and designating a block to be updated.

26) An electronic information distributing apparatus according to claim 22, wherein an arbitrary block of electronic information includes succession information which is added as a result of a user operation; and, when updating the electronic information, the updating processor maintains the succession information as succession information for the new updated block.

27) An electronic information distributing apparatus according to claim 26, wherein succession information is information added to electronic information by a user operation.

28) An electronic information distributing apparatus according to claim 26, wherein succession information includes data for linking information added to electronic information by a user operation with the corresponding block of the electronic information.

29) An electronic information distributing apparatus according to claim 22, further comprising an updating fee computing unit for computing an updating fee per updated block and for charging the updating fee.

30) A computer-readable recording medium having recorded thereon a computer program comprising the steps of:
performing data communication with a container storing electronic information;
reading the electronic information through an interface, detecting the version of each block of the electronic information, and determining whether or not to update the electronic information in block units;
displaying a block to be updated on the basis of the determination result; and
transmitting only the designated block to the container through the interface and updating the corresponding block.

31) A computer-readable recording medium according to claim 30, wherein the computer program further comprises the step of selecting and designating the block to be updated.

32) A computer-readable recording medium according to claim 30, wherein, when succession information is added to an arbitrary block of electronic information, the computer program further comprises the step of maintaining the succession information as succession information for a new updated block when updating the electronic information.

33) A computer-readable recording medium according to claim 30, wherein the computer program further comprises the step of computing an updating fee in units of updated blocks and charging the updating fee.
